(19) United States
(12) Patent Application Publication
(10) Pub. No.: US 2007/0186896 A1
(43) Pub. Date: Aug. 16, 2007

(54) Motor Vehicle

(76) Inventors: Stephan Carroll, Wadhurst (GB); Jon Caine, South Woodham Ferrers (GB); Antonis Dris, Chelmsford (GB); Roy Clissold, Wickford (GB)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/672,185

(22) Filed: Feb. 7, 2007

(30) Foreign Application Priority Data
Feb. 10, 2006 (GB) 0602674.4

(51) Int. Cl. F02B 67/06; F02B 77/08

(52) U.S. Cl. 123/198 R

(57) ABSTRACT

A motor vehicle 5 is disclosed having an engine 10 used to drive a number of ancillary devices 12, 14, 16 and 18 via an ancillary drive 11. An electronically controlled disengageable connection 21 is provided to selectively disengage the drive from the engine 10 to the ancillary drive 11 when a high power output is required from the engine 10 to drive the motor vehicle 5. When the ancillary drive 11 is disengaged a source of motive power 12 is used to power the ancillary devices 14, 16 and 18 so as to maintain their operation.

### FIELD OF THE INVENTION

This invention relates to motor vehicles and in particular to the control of an internal engine for a motor vehicle.

### SUMMARY OF THE INVENTION

In order to meet increasing emission standards and reduce the running costs of a motor vehicle it is becoming increasingly common to use an engine in a motor vehicle of reduced capacity producing less power. This has an adverse effect on the accelerative ability of the motor vehicle which can be a problem in certain situations such as when an overtaking manoeuvre is required. The problem is made worse because of the increasing use of air-conditioning and power steering on small vehicles because these devices consume a considerable amount of power.

It is an object of this invention to provide a motor vehicle having an improved performance.

According to a first aspect of the invention there is provided a motor vehicle having an internal combustion engine, an ancillary drive to driveably connect one or more ancillary devices to an output from the engine, a disengageable connection interposed between the output from the engine and the ancillary drive to permit the ancillary drive to be disengagaged from the engine and a controller to control the disengageable connection wherein, when at least one vehicle operating condition indicating that a high power output is required from the engine is present, the disengageable connection is disengaged and a source of motive power driveably connected to the ancillary drive is energised to drive the one or more ancillary devices.

The disengageable connection may be a clutch controlled by the controller.

The source of motive power may be one of an electric machine, a hydraulic motor and a steam powered motor.

The source of motive power may be an electric machine forming one of the one or more ancillary devices driveably connected to the engine by the ancillary drive.

The electric machine may be a motor/generator used to start the engine.

The one or more ancillary devices may comprise at least one of a power assisted steering pump, an air-conditioning compressor, an engine coolant pump and an electrical generator.

The vehicle operating condition may be one of an input from an accelerator pedal indicating that a high power output is demanded, a signal from a driver operated switch used to request a high power output from the engine and an indication that the motor vehicle is unable to maintain the current forward speed even though an accelerator pedal is fully depressed.

The output from the engine may be a crankshaft of the engine.

The controller may be part of a control system used to control operation of the engine and to energise the source of motive power.

### BRIEF DESCRIPTION OF THE DRAWING

The invention will now be described by way of example with reference to the accompanying drawing of which:

FIG. 1 is a side view of a motor vehicle according to the invention;

FIG. 2 is a schematic front view of an engine forming part of a motor vehicle according to the invention; and

FIG. 3 is a plan view of the engine shown in FIG. 2.

### DETAILED DESCRIPTION OF A PREFERRED EMBODIMENT

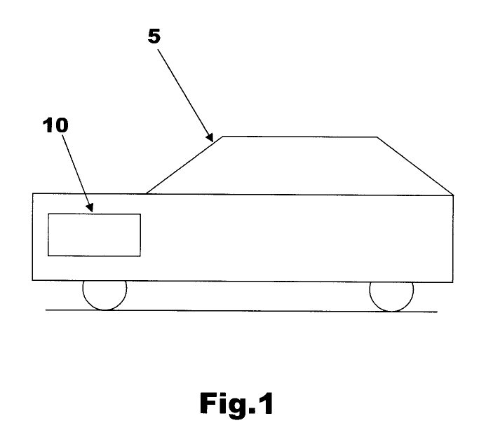

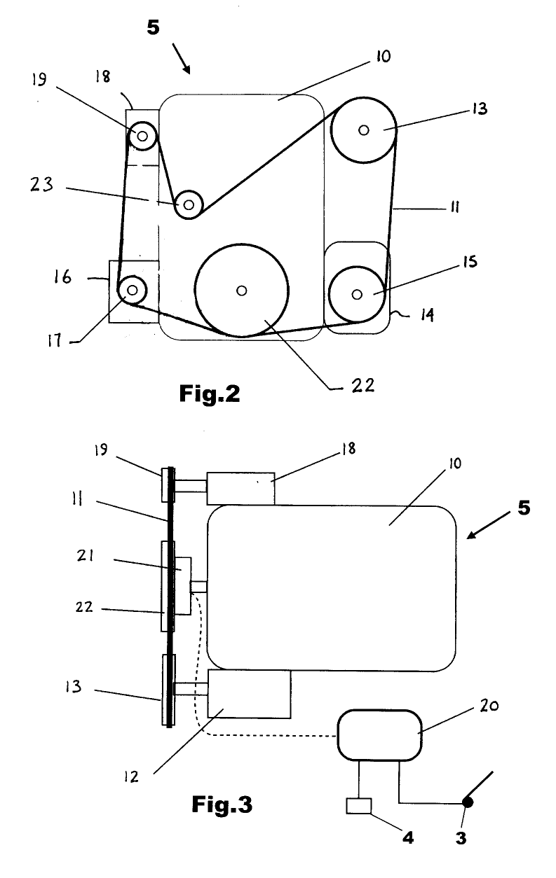

With references to FIGS. 1 to 3 there is shown a motor vehicle 5 having an internal combustion engine 10 used to provide motive power to the motor vehicle 5. The engine 10 is controlled by an engine control system (not shown) which may include a facility to automatically stop and start the engine 10 when one or more predetermined vehicle operating conditions are met.

The engine 10 is driveably connected via a disengageable connection 21 to an ancillary drive which in this case is in the form of a continuous belt 11 but could alternatively be a chain drive or a gear drive.

The disengageable connection is formed by a clutch 21 which is connected on an input side to an output from the engine 10 in the form of a crankshaft of the engine 10 and on an output side to a main or crank pulley 22 used to transmit drive to the belt 11. The term ‘clutch’ as meant herein includes devices that permit relative rotation between input and output side of the clutch during disengagement and re-engagement such as a friction clutch or wet clutch and devices that provide only full engagement or full disengagement such as a dog clutch.

The ancillary drive in this case drives four ancillary devices in the form of a motor/generator 12, an air-conditioning compressor 14, a power steering pump 16 and a coolant pump 18. It will be appreciated that more or less ancillary devices could be driven by the belt 11 than those shown.

The motor/generator 12 is driven by the belt 11 via a pulley 13 which is drivingly engaged with the belt 11 and in this case the motor/generator is an integrated starter/generator 12 which is used to not only generate electricity to charge an electrical storage device such as a battery (not shown) but is also used to start the engine 10.

The air-conditioning compressor 14 is driven by the belt 11 via a pulley 15 which is drivingly engaged with the belt 11, the power steering pump 16 is driven by the belt 11 via a pulley 17 which is drivingly engaged with the belt 11 and the coolant pump 18 is driven by the belt 11 via a pulley 19 which is drivingly engaged with the belt 11. A belt tensioner pulley 23 is provided to maintain sufficient tension in the belt 11 to prevent slippage. It will be appreciated that other belt tensioning means could be used.

The clutch 21 is electronically controlled by a controller 20 which may form part of the engine control system or may, as shown, be a separate unit. In either case, the controller 20 is operatively connected to a driver input device such as an accelerator pedal 3 or a power boost switch 4 used to indicate that a high power output is required from the engine 10. It will be appreciated that in most case only one type of driver input device will be used as a signal by the controller 20 to control the operation of the clutch 21.

If the controller 20 is connected to the accelerator pedal 3 then, when the accelerator pedal 3 is moved to a position indicating that the demanded power output is more than a predetermined amount such as for example 75% of maximum, the controller 20 is operable to disengage the clutch 21 so that the belt 11 is no longer driven by the output from the engine 10.

Similarly, if the motor vehicle 5 is fitted with a power boost switch 4 then, when the power boost switch 4 is operated by a driver of the motor vehicle 5, the controller 20 is operable to disengage the clutch 21 so that the belt 11 is no longer driven by the output from the engine 10.

In both cases, when the clutch 21 is disengaged, the motor/generator 12 is energised at the same time to drive the belt 11 and thereby drive the other ancillary devices 14, 16 and 18 so as to keep them operating even though the drive from the engine 10 has been interrupted. This means that, irrespective of the demands placed upon the ancillary devices 14, 16 and 18, the engine 10 can be temporarily freed of the load normally applied by the ancillary devices so as to provide all of its output power to driving the vehicle.

This can have a dramatic effect on the performance of the motor vehicle if it is fitted with a low power engine and will still be of some assistance even if the engine is of a higher output. For example, the total load of the ancillary devices can be more than 10 kW and so if the engine has a maximum output of only 50 kW an approximate 20% increase in performance can be obtained. Therefore, by using the clutch 21 to disengage the ancillary devices from the engine 10 when an operating condition requiring a high power output from the engine 10 occurs, a significant improvement in motor vehicle acceleration or climbing ability can be obtained.

The vehicle operating condition can be, amongst others, an indication that the accelerator pedal 3 has been depressed more than a predetermined amount, that a driver controlled device such as the boost switch 4 has been operated or a signal from an engine control system that maximum engine power is required, such as may be the case when the motor vehicle is climbing a hill and is unable to maintain the current forward speed even though the accelerator pedal 3 is fully depressed.

If, as in this case, an electric motor is used for the source of motive power then the state of charge or energy level of the source of electrical power for the electric motor is monitored to ensure that it does not drop below a safe level. If the energy stored in the source of electrical energy drops below the safe level then a warning will be provided that power boost is inactive and the clutch 21 will remain engaged irrespective of the driver input from the accelerator pedal 3 or the power boost switch 4 received by the controller 20.

Although the source of motive power used to drive the belt 11 when the clutch is disengaged is, in this case, one of the ancillary devices normally driven by the belt when the clutch 21 is engaged, this need not be the case and a separate electric motor or other form of motive power such as a hydraulic motor or steam powered turbine/motor could be used for this purpose.

It will be appreciated that such an additional power output can only be supplied for a short period of time if an electric machine is used to power the ancillary devices because of the need to maintain a safe energy limit in the electrical storage device used to power the electric machine. However, this may not be the case if a steam powered device is used if the steam is produced from excess heat generated by the engine 10.

When the conditions demanding a power boost no longer exist or a power boost can no longer be provided the clutch 21 is automatically re-engaged so that the engine 10 once more drives the ancillary devices 12, 14, 16 and 18.

An indicator device such as a light or instrument display may be provided to a user of the motor vehicle to indicate when a power boost is possible and may further indicate when a power boost is to be automatically terminated or in unavailable. For example, a green light may be illuminated to indicate that a power boost is possible, a red light may be illuminated to indicate that a power boost is not possible and the red light may start to flash when a power boost is to be automatically terminated.

It will be appreciated that, although the engine 10 as previously described is the engine of a micro-hybrid vehicle, the invention could also be applied to any other type of motor vehicle and is not limited to use on low power motor vehicles, micro-hybrid vehicles or full hybrid vehicles. However, the provision of power boost is particularly advantageous in the case of a micro-hybrid or hybrid vehicle because the clutch 21 can be used to improve stop start operation by increasing the number of opportunities to stop the engine because no account has to be taken of the demands from the ancillary devices.

It will be appreciated by those skilled in the art that although the invention has been described by way of example with reference to one or more embodiments it is not limited to the disclosed embodiments and that modifications to the disclosed embodiment or alternative embodiments could be constructed without departing from the scope of the invention.

We claim:

1. A motor vehicle having an internal combustion engine, an ancillary drive to driveably connect one or more ancillary devices to an output from the engine, a disengageable connection interposed between the output from the engine and the ancillary drive to permit the ancillary drive to be disengagaged from the engine, and a controller to control the disengageable connection, wherein when at least one vehicle operating condition indicating that a high power output is required from the engine is present, the disengageable connection is disengaged and a source of motive power driveably connected to the ancillary drive is energised to drive the one or more ancillary devices.

2. A motor vehicle as claimed in claim 1 wherein the disengageable connection is a clutch controlled by the controller.

3. A motor vehicle as claimed in claim 1 wherein the source of motive power is one of an electric machine, a hydraulic motor and a steam powered motor.

4. A motor vehicle as claimed in claim 1 wherein the source of motive power is an electric machine forming one of the one or more ancillary devices driveably connected to the engine by the ancillary drive.

5. A motor vehicle as claimed in claim 4 wherein the electric machine is a motor/generator used to start the engine.

6. A motor vehicle as claimed in claim 1 wherein the one or more ancillary devices comprises at least one of a power assisted steering pump, an air-conditioning compressor, an engine coolant pump and an electrical generator.

7. A motor vehicle as claimed in claim 1 wherein the vehicle operating condition is one of an input from an accelerator pedal indicating that a high power output is demanded, a signal from a driver operated switch used to request a high power output from the engine and an indication that the motor vehicle is unable to maintain the current forward speed even though an accelerator pedal is fully depressed.

8. A motor vehicle as claimed in claim 1 wherein the output from the engine is a crankshaft of the engine.

9. A motor vehicle as claimed in claims 1 wherein the controller is part of a control system used to control operation of the engine and to energise the source of motive power.
